(19) United States
(12) Patent Application Publication
(10) Pub. No.: US 2025/0180123 A1
(43) Pub. Date: Jun. 5, 2025

(54) VALVE FOR A REFRIGERATION APPLICATION

(71) Applicant: Danfoss A/S, Nordborg (DK)

(72) Inventors: Shuwei LIU, Wuqing (CN); Yanning (Mars) SHEN, Wuqing (CN)

(21) Appl. No.: 18/844,251

(22) PCT Filed: Feb. 1, 2023
(86) PCT No.: PCT/EP2023/052456

§ 371 Date: Sep. 5, 2024

(30) Foreign Application Priority Data
Mar. 23, 2022 (DK) PA202200249

(51) Int. Cl. F16K 1/36; F16K 1/46; F25B 41/24

(52) U.S. Cl. CPC F16K 1/36; F16K 1/46; F25B 41/24

(57) ABSTRACT

A refrigeration application, in particular a shut-off and/or regulating valve includes a bonnet connected to a housing with two fluid openings, a spindle and a piston for opening and closing a fluid passage between the two fluid openings. The spindle engages the piston for moving it between a closed position and an open position of the valve. A bottom closing portion of the piston includes an outer flange and an inner flange between which a sealing element is provided, wherein the two flanges are connected to each other by means of at least one screw and wherein a non-circular connector geometry for connecting a tool is provided at the bottom side of the outer flange.

### CROSS-REFERENCES RELATED TO APPLICATIONS

This application is a National Stage application of International Patent Application No. PCT/EP2023/052456, filed on Feb. 1, 2023, which claims priority to Danish Patent Application No. PA202200249, filed on Mar. 23, 2022, each of which is hereby incorporated by reference in its entirety.

### TECHNICAL FIELD

The present invention pertains to a valve for a refrigeration application, in particular a shut-off and/or regulating valve.

### BACKGROUND

In known valves for refrigeration applications, sealing elements are used for sealing a fluid passage between two fluid openings in the valve's closed state. Prior to the use of the valve, the correct sealing element needs to be connected to the remainder of the valve. The valve may be delivered with a number of different sealing elements. The user of the valve choses the most suitable sealing element for a given application and/or type of refrigerant. The most suitable sealing is then connect to the valve.

During the operation of the valve, the sealing element may deteriorate to a degree, in which the correct operation of the valve is no longer possible. When servicing such valves, it may therefore be necessary to exchange a deteriorated sealing element for a new one.

In order to exchange a deteriorate sealing element, it is necessary to open the valve and to separate the two flanges holding the sealing element. When unscrewing the two flanges, it is necessary to counteract the torque applied by a tool, such that the screw can be screwed out of and into the flanges. As the flanges and the piston are mostly circular, it is not easy to apply a tool counteracting the torque.

### SUMMARY

The aim of the present invention is to overcome this problem and to provide a valve, which is easier to service. This aim is achieved by a valve according to claim 1. Preferable embodiments are subject to the dependent claims.

According to the invention, a valve for a refrigeration application is provided. The valve may be a shut-off and/or regulating valve, comprising a bonnet connected to a housing with two fluid openings, a spindle and a piston for opening and closing a fluid passage between the two fluid openings, wherein the spindle engages the piston for moving it between a closed position and an open position of the valve, wherein a bottom closing portion of the piston comprises an outer flange and an inner flange between which a sealing element is provided, wherein the two flanges are connected to each other by means of at least one screw and wherein a non-circular connector geometry for connecting a tool is provided at the bottom side of the outer flange.

The non-circular connector geometry may be any geometry to which a tool such as an allen key or a screwdriver may be connected, such that a rotation of the piston may be inhibited by means of said tool. The positioning of the connector geometry on the same side as the screw facilitates the access to the connector geometry.

In a preferred embodiment of the invention, the connector geometry has an angular, in particular hexagonal shape and/or the connector geometry is fluidly connected to a pressure balancing passage. The connector geometry may therefore provide two functions to the valve, i.e. providing a connection surface for a tool and providing at least a part of the pressure balancing passage.

In another preferred embodiment of the invention, the connector geometry comprises a recess and/or a protrusion. The connector geometry may be surrounded by a flat surface of the outer flange.

In another preferred embodiment of the invention, the connector geometry is concentrically aligned only with non-threaded portions of the piston. The non-threaded portion may be a hole or a passage in the piston. For example, the connector geometry may be a part or a prolongation of a pressure balancing passage and not of a threaded hole of the piston.

In another preferred embodiment of the invention, the connector geometry extends along a central axis of the piston. The connector geometry may be aligned at or close to the central axis of the piston. The central position of the connector geometry facilitates the connection and holding of a tool, while the screws are being unscrewed from or screwed to the piston.

In another preferred embodiment of the invention, the valve is a service valve and/or the connector geometry is provided between two, three or more screws for connecting the two flanges to each other. The screws may be arranged in a circular pattern around the connector geometry for even pressure distribution between the outer flange and the sealing element.

In a particularly preferred embodiment of the invention, the connector geometry is oriented such that the tool does not impair access to the screws when connected to the connector geometry. When the tool is connected to the valve, a handle of the tool may be positioned between two screws rather than covering one screw.

In another preferred embodiment of the invention, the at least one screw and the connector geometry are provided on the same side of the piston. The at least one screw and the connector geometry may be provided on one side of the outer flange, such that they are all accessible from the same direction.

### BRIEF DESCEIPTION OF THE DRAWINGS

Further advantages and details of the invention are described with reference to the figures. The figures show:

FIG. 1: a sectional view of the valve in its closed position;

FIG. 2: a sectional view of the valve in its open position;

FIGS. 3a, 3b: different views of valve components with attached tools; and

FIG. 3c: a top view of valve components with the connector geometry and screws.

### DETAILED DESCRIPTION

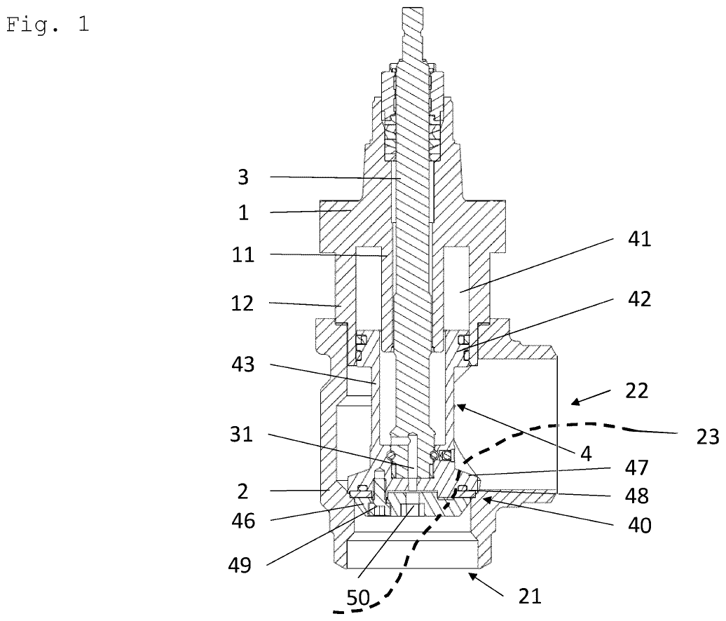

FIG. 1 shows a sectional view of an embodiment of the valve in its closed position. The valve is provided for a refrigeration application. The valve may be a shut-off and/or regulating valve. It comprises a bonnet 1 connected to a housing 2 with two fluid openings 21, 22. A spindle 3 is connected to a piston 4 for opening and closing a fluid passage 23 between the two fluid openings 21, 22. The piston 4 is provided between the bonnet 1 and the housing 2. The piston 4 comprises a number of subcomponents. In order to provide the piston 4 inside the housing 2 and 1 bonnet, the housing 2 may have to be detached from the bonnet 1. In this disassembled state of the valve, the piston 4 may be connected to the spindle 3.

Once the spindle 3 is connected to the piston 4 and the bonnet 1 is connected to the housing 2, the spindle 3 can be turned by an operator or an actuator. It engages the piston 4 for moving it between a closed position and an open position of the valve. The components of the piston 4 comprise a bottom closing portion 40 with an outer flange 46 and an inner flange 47. The inner flange 47 may be formed integrally with a piston tube 43. The piston tube 43 may be the central part of the piston 4. The piston 4 may further comprise an upper guiding and sealing portion 42, which guides and seals the piston 4 against the bonnet 1. The upper guiding and sealing portion 42 may be the uppermost part of the piston 4 and/or the only part of the piston 4, which is sealed against the bonnet 1. The upper guiding and sealing portion 42 may be guided between two concentric hollow-cylindrical protrusions 11, 12. The hollow-cylindrical protrusions 11, 12 may be formed integrally with the bonnet 1.

The valve comprises a pressure balancing chamber 41 between the bonnet 1 and the upper portions of the piston 4. The pressure balancing chamber 41 varies in size and shape in dependence on the valves position. In the fully closed position of the valve shown in FIG. 1, the pressure balancing chamber 41 is shown at its greatest volume.

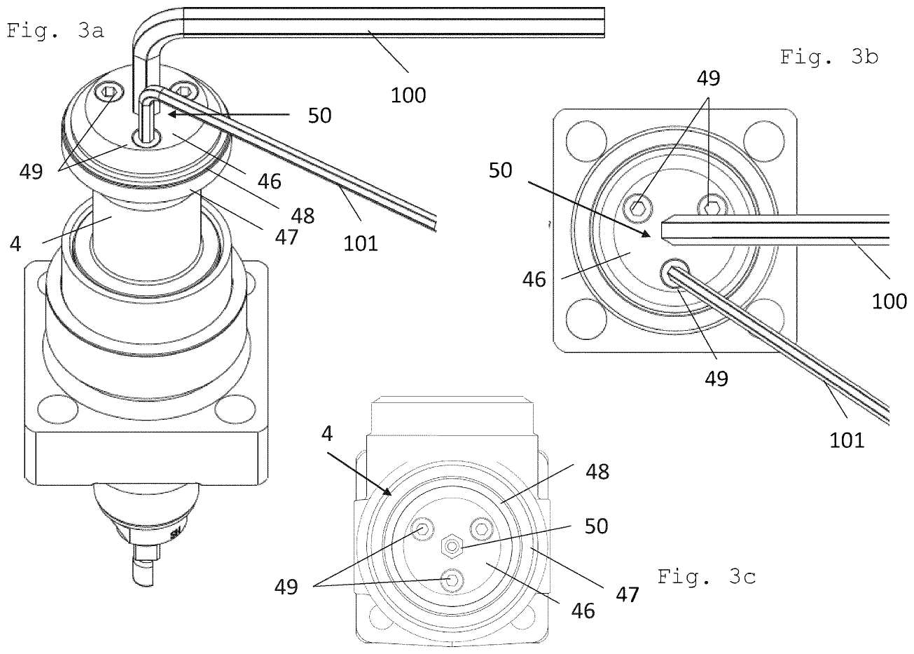

Between the two flanges 46, 47 of the piston 4, a sealing element 48 is provided. The two flanges 46, 47 are connected to each other by means of at least one screw 49. The at least one screw 49 applies a force on the outer flange 46 which pushes the outer flange 46 against the sealing element 48 and the inner flange 47. A non-circular connector geometry 50 for connecting a tool 100 is provided at the bottom side of the outer flange 46. The tool 100 is shown in FIGS. 3a and 3b later on.

The connector geometry 50 may be formed as a recess as shown in FIG. 1. Alternatively or additionally, the connector geometry 50 may comprise a protrusion. For example, the connector geometry 50 may comprise a hexagonal protrusion protruding from the bottom surface of the outer flange 46. Additionally, the pressure balancing passage 31 may be provided within the protruding connector geometry 50. The connector geometry 50 may reach further into the outer flange 46 than a countersink or counterbore for the screw 49. Any suitable combination of protruding and recessed portions may be employed. The connector geometry 50 may be surrounded by a flat surface of the outer flange 46.

The connector geometry 50 may be concentrically aligned only with non-threaded portions of the piston 4. The non-threaded portion may be a hole or it may be the pressure balancing passage 31 in the piston 4. In the shown embodiment, the connector geometry 50 is a part or a prolongation of the pressure balancing passage 31 and not of a threaded hole of the piston 4. The threaded holes accommodating the screws 49 are shorter than the pressure balancing passage 31.

The connector geometry 50 extends along a central axis of the piston 4. The connector geometry 50 may be aligned at or close to the central axis of the piston 4. The central position of the connector geometry 50 facilitates the connection and holding of a tool 100, while the screws are being unscrewed from the piston 4.

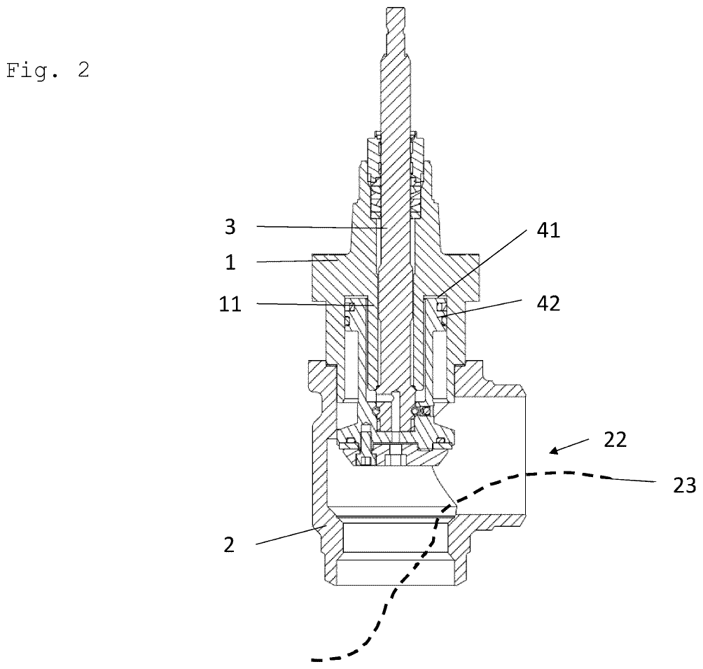

FIG. 2 shows a sectional view of the valve in its fully open position. The upper guiding and sealing portion 42 is moved away from the housing 2 and into the bonnet 1. The spindle 3 abuts the bottom portion of the inner concentric protrusion 11. The contact between the spindle 3 and the bottom portion of the inner concentric protrusion 11 seals the valve against the outside in the open position of the valve. The pressure balancing chamber 41 is shown with greatly reduced volume in the open position of the valve. The size and shape of the pressure balancing chamber 41 depend on the position of the piston 4 relative to the bonnet 1.

FIGS. 3a and 3b show different views of valve components with an attached tool 100. The embodiment of FIGS. 3a and 3b show that the connector geometry 50 is oriented such that the tool 100 does not impair access to the three screws 49. As the connector geometry 50 is covered and filled by the tool 50, the reference sign 50 only points in the direction of the covered connector geometry 50. In this embodiment, the connector geometry 50 is oriented such that the tool 100 is directed between two screws 49, when the tool 100 is connected to the connector geometry 50. Hence, when the tool 100 is connected to the valve, a handle of the tool 100 may be positioned between two screws 49 rather than covering one screw 49. In the case of a hexagonal connector geometry 50, one edge of the hexagon needs to be oriented between two adjacent screws 49 for achieving the desired orientation of the tool 100.

As can be seen, the screws 49 and the connector geometry 50 are provided on the same side of the piston 4, namely the bottom most part of the piston 4. The at least one screw 49 and the connector geometry 50 may be provided on one side of the outer flange 46, such that they are all accessible from the same direction.

The non-circular connector geometry 50 may be any geometry to which a tool 100 such as an allen key or a screwdriver may be connected. Once the tool 100 is connected to the connector geometry 50, a rotation of the piston 4 may be inhibited by means of said tool 100. The inhibition of the piston 4 rotation is necessary when screwing the screws 49 by means of a second tool 101. The positioning of the connector geometry 50 on the same side as the screws 49 facilitates the access to the connector geometry 50.

The connector geometry 50 may have an angular, in particular hexagonal shape for receiving e.g. an allen key. The connector geometry 50 may be fluidly connected to a pressure balancing passage 31.

FIG. 3c shows a top view of valve components with the connector geometry 50 and screws 49. The connector geometry 50 is provided between three screws 49 for connecting the two flanges 46, 47 to each other. More or less screws 49 may be employed. It is preferable to arrange the screws 49 in a circular pattern for even pressure distribution between the outer flange 46 and the sealing element 48.

While the present disclosure has been illustrated and described with respect to a particular embodiment thereof, it should be appreciated by those of ordinary skill in the art that various modifications to this disclosure may be made without departing from the spirit and scope of the present disclosure.

What is claimed is:

1. A valve for a refrigeration application, in particular a shut-off and/or regulating valve, comprising a bonnet connected to a housing with two fluid openings, a spindle and a piston for opening and closing a fluid passage between the two fluid openings, wherein the spindle engages the piston for moving it between a closed position and an open position of the valve, wherein a bottom closing portion of the piston comprises an outer flange and an inner flange between which a sealing element is provided, wherein the two flanges are connected to each other by means of at least one screw and wherein a non-circular connector geometry for connecting a tool is provided at the bottom side of the outer flange.

2. The valve according to claim 1, wherein the connector geometry has an angular, in particular hexagonal shape and/or that the connector geometry is fluidly connected to a pressure balancing passage.

3. The valve according to claim 1, wherein the connector geometry comprises a recess and/or a protrusion.

4. The valve according to claim 1, wherein the connector geometry is concentrically aligned only with non-threaded portions of the piston.

5. The valve according to claim 1, wherein the connector geometry extends along a central axis of the piston.

6. The valve according to claim 1, wherein the valve is a service valve.

7. The valve according to claim 1, wherein the connector geometry is provided between two, three or more screws for connecting the two flanges to each other.

8. The valve according to claim 7, wherein the connector geometry is oriented such that the tool does not impair access to the screws when connected to the connector geometry.

9. The valve according to claim 1, wherein the at least one screw and the connector geometry are provided on the same side of the piston.

10. The valve according to claim 2, wherein the connector geometry comprises a recess and/or a protrusion.

11. The valve according to claim 2, wherein the connector geometry is concentrically aligned only with non-threaded portions of the piston.

12. The valve according to claim 3, wherein the connector geometry is concentrically aligned only with non-threaded portions of the piston.

13. The valve according to claim 2, wherein the connector geometry extends along a central axis of the piston.

14. The valve according to claim 3, wherein the connector geometry extends along a central axis of the piston.

15. The valve according to claim 4, wherein the connector geometry extends along a central axis of the piston.

16. The valve according to claim 2, wherein the valve is a service valve.

17. The valve according to claim 3, wherein the valve is a service valve.

18. The valve according to claim 4, wherein the valve is a service valve.

19. The valve according to claim 5, wherein the valve is a service valve.
